(19) United States
(12) Patent Application Publication
(10) Pub. No.: US 2009/0134548 A1
(43) Pub. Date: May 28, 2009

(54) Method for Producing a Signal Plate and Traffic Signal With Such a Signal Plate

(75) Inventor: Michael Marti, Winterthur (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Schweiz AG, Zurich (CH)

(21) Appl. No.: 12/086,066

(22) PCT Filed: Oct. 31, 2006
(86) PCT No.: PCT/EP2006/010481

§ 371 Date: Jun. 5, 2008

(51) Int. Cl. B29C 45/14; G08G 1/095

(52) U.S. Cl. 264/232; 340/907

(57) ABSTRACT

To produce a signal plate for a railway signal, a casting mold corresponding to an external form of the signal plate is provided. At least one luminous point is inserted into the casting mold, and the casting mold is filled with a free-flowing curable plastic to create a casting. The plastic is cured, and the casting is removed.

The present invention relates to a method for producing a signal plate and a traffic signal with a signal plate produced according to the above method.

Different types of traffic signals are currently used to control traffic flows. On the railways train traffic is predominantly still controlled using light signals, which may be of widely differing types. All light signals generally have in common a signal plate, into which the luminous points are inserted. This signal plate is traditionally made of metal and designed for stability reasons either with elements that are curved at the sides and/or with a second supporting metal plate. The holes for the individual luminous points have to be created in the signal plate and the luminous points then have to be inserted into the holes and secured there. The metalworking required to do this means the method is complex and makes it necessary to provide further elements on the signal plate to secure the luminous points.

The object of the present invention is therefore to specify a method which can be used to provide a traffic signal with less outlay. A traffic signal of such type will also be specified.

According to the invention this object is achieved with regard to the method by a method for producing a signal plate, in particular a signal plate for a railway signal, which comprises the following method steps:

a) providing a casting mold corresponding to the external form of the signal plate;
b) inserting at least one luminous point and/or at least one empty receptacle into the casting mold;
c) filling the casting mold with a free-flowing curable plastic to create a casting;
d) curing the plastic; and
e) removing the casting and in the case of cast-in empty receptacles inserting luminous points into the empty receptacle.

This allows the signal plate to be produced in a very simple manner, because the working process is simplified very significantly, in that the luminous points and/or the empty receptacles are positioned in the positions provided for them and are held by friction lock and form fit during the course of the casting process and the subsequent curing. Further processing steps to secure the luminous points and/or the empty receptacles are no longer required. It should be noted that a luminous point here refers to an insert with an integrated or integrable light source (e.g. an incandescent lamp, LED, etc.).

It is comparatively simple to arrange the luminous points and/or the empty receptacle, if the luminous point and/or the empty receptacle has an essentially cylindrical housing and is inserted into the casting mold in an essentially perpendicular orientation to the plane of the casting mold. In principle however the housing can have any cross-sectional form because the free-flowing nature of the plastic allows easy adjustment to pretty well any cross-sectional forms.

In order on the one hand to have to use comparatively little plastic and on the other hand still to achieve sufficiently firm anchoring of the luminous point and/or the empty receptacle in the plastic, in one embodiment of the invention provision can be made to cast the luminous point and/or the empty receptacle to a depth corresponding to its diameter as a maximum.

To increase the mechanical stability of the signal plate before filling the casting mold at least one structurally reinforcing element can be inserted into the casting mold. This structurally reinforcing element can then be cast in together with the luminous point and/or the empty receptacle in a single operation. It is thus possible to avoid the arrangement of further structurally reinforcing elements, which means that further manufacturing steps compared with conventional metal signal plates can be omitted. One structurally reinforcing element that is particularly preferred due to its ease of handling can be a glass-fiber mat for example.

To reliably prevent the plastic cast into the casting mold flowing under the luminous point and/or the empty receptacle, the luminous point and/or the empty receptacle can be pressed onto the casting mold when the casting mold is filled.

In order for example to allow the luminous point and/or the empty receptacle to move out of the plane of the signal plate, the casting mold can have at least one projection, into which the luminous point and/or the empty receptacle is inserted. The at least one projection can also be formed so that formed elements assigned to the luminous point and projecting from the plane of the signal plate, in particular protective or screening elements, are produced at the same time during filling. It is thus possible to form side shutters, extensions or other elements projecting from the plane of the signal plate directly when casting the signal plate. These elements can be connected to the luminous point and/or the empty receptacle permanently at the same time.

In order to be able to configure these in a particularly stable manner out of the plane of the signal plate, it is possible, before filling the casting mold, to insert at least one further structurally reinforcing element into the projection. Particularly suitable for this purpose is for example the above-mentioned glass-fiber mat, which is bent into the projection in the regions on which a luminous point and/or an empty receptacle would otherwise rest. Therefore the holes in the glass-fiber mat for the luminous points and/or the empty receptacle are not cut out as such and the cut-out sections removed but with a corresponding cut from the center of the hole radially to the edge, the segments still held at the edge of the hole can be folded into the projection and cast in there later with the plastic.

According to the invention the above-mentioned object is achieved with regard to the traffic signal by a traffic signal, in particular a railway signal, which has a signal plate produced by casting plastic, into which at least one luminous point and/or at least one empty receptacle is cast with a friction lock and form fit.

In an advantageous development of the invention to achieve a sufficiently high level of stability at least one structurally reinforcing element, in particular a glass-fiber mat, can be cast into the signal plate.

Exemplary embodiments of the invention are described in more detail below with reference to the drawing, in which:

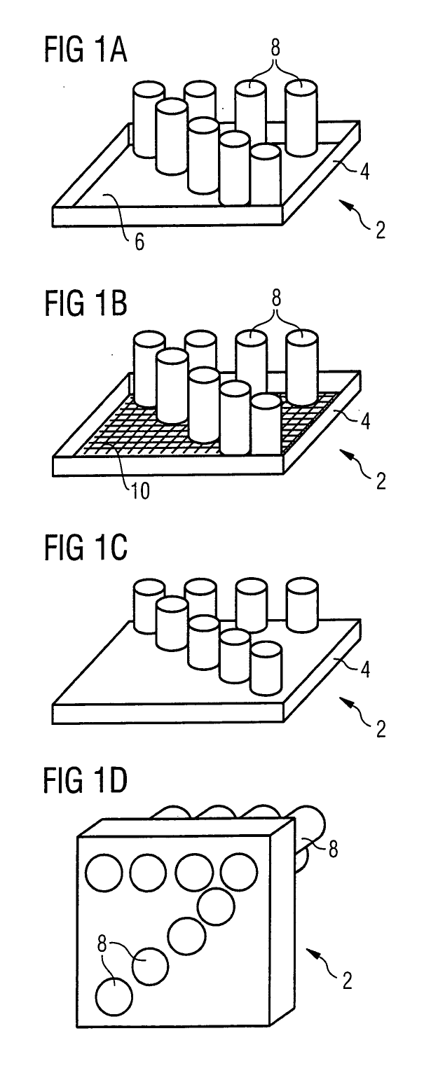

FIG. 1 shows a schematic diagram of the most important steps a) to d) for producing a first signal plate; and

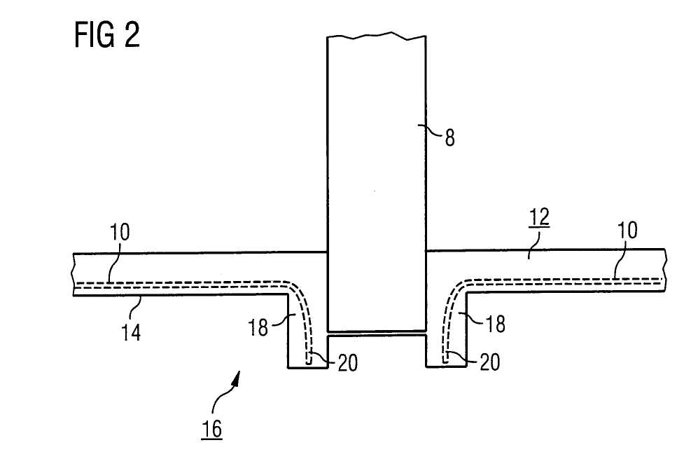

FIG. 2 shows a longitudinal section through a second signal plate in the region of a luminous point.

FIG. 1 shows a schematic diagram of the essential production steps a) to d) for producing a signal plate 2 according to the present invention. In the first step a) a casting mold 4 corresponding to the external form of the signal plate 2 is provided, which generally has an essentially flat signal surface 6 facing a traffic system user (not shown). Luminous points 8 are inserted into this casting mold in positions which correspond to the place subsequently provided for the luminous points within the signal plate 2. These luminous points 8 can already comprise the entire luminous device and the required connecting material. Alternatively it would also be possible to insert so-called empty receptacles into the casting mold 4 instead of the luminous points 8, in which the luminous point 8 is later incorporated, for example by screwing the luminous point 8 into a thread in the empty receptacle.

In step b) a glass-fiber mat 10 is then inserted into the casting mold 4 avoiding the area provided for the luminous points 8. The glass-fiber mat 10 serves as a structurally reinforcing element rendering further strengthening of the signal plate 2 unnecessary. In step c) the casting mold 4 is filled with a free-flowing, curable plastic to create a cohesive casting with the integrated luminous points 8 and the simultaneously cast-in glass-fiber mat 10. An epoxy resin, which is a combination of a liquid resin and a hardening agent, which is cast and then hot-cured, is suitable for this purpose. Additionally or alternatively polyurethane and/or even laminated carbon fibers, so-called composite materials, can be used.

Alternatively a little of the plastic could be cast first into the casting mold and the glass-fiber mat 10 laid on top of the still soft plastic and the casting mold 4 then filled. Curing the plastic gives the finished signal plate 2, as shown in a front view in step d), which is then removed from the casting mold 4. In the case of cast-in empty receptacles the luminous points 8 would then have to be inserted into the empty receptacles.

As shown in FIG. 1, the luminous points 8 have an essentially cylindrical housing and are inserted into the casting mold 4 essentially perpendicular to the plane of the casting mold 4. Of course it would also be possible with a corresponding configuration of the casting mold 4 to stand the luminous points 8 not at a right angle but for example with a slight inclination. Also the casting mold 4 can generally have positioning aids, which ensure that the luminous points 8 are repeatedly arranged at the same point in the signal plate 2 so that identical signal plates can be produced in a simpler manner.

The ratios in FIG. 1 and also in FIG. 2 show clearly that the luminous points 8 are cast to a depth, which corresponds to less than their diameter.

In the selected diagram in FIG. 1 it is not shown in detail that the luminous points 8 are pressed onto the casting mold 4 when the casting mold 4 is filled. It is possible thus to prevent liquid plastic flowing under the luminous points 8 and making the lens of a luminous point 8 for example unusable.

FIG. 2 shows a longitudinal cross-section in the region of a luminous point 8 of a second signal plate 12, which is still in its associated casting mold 14. This casting mold 14 has a projection 16, into which the luminous point 8 is inserted. It is thus possible for the luminous point 8 to intersect the plane of the signal plate 12. The projection 16 is also formed so that formed elements assigned to the luminous point 8 and projecting from the plane of the signal plate 12, in the present instance a protective screen 18, can be produced at the same time during filling. During manufacture, before the casting mold 14 was filled, at least one further structurally reinforcing element was inserted into the projection 16, in order to be able to configure the protective screen 18 in particular in a similarly sufficiently stable manner. To this end in this instance a region 20 of the glass-fiber mat 10, on which the luminous point 8 would otherwise have rested, was bent into the projection 16.

The signal plates 2, 14 described above can thus be integrated in a simple manner in a traffic signal, for example a railway signal. The signal plates 2, 12 used in this process are simple to manufacture, because the working process is greatly simplified, in that the luminous points 8 and/or the empty receptacles are positioned at the places provided for them and are held by friction lock and form fit during casting and the subsequent curing. Further substantial processing steps to secure the luminous points 8 and/or the empty receptacles are no longer required.

1.-12. (canceled)

13. A method for producing a signal plate, comprising:
providing a casting mold corresponding to an external form of the signal plate;
inserting at least one luminous point into the casting mold;
filling the casting mold with a free-flowing curable plastic to create a casting;
curing the plastic; and
removing the casting.

14. The method of claim 13, wherein the luminous point has a substantially cylindrical housing and is inserted into the casting mold in a substantially perpendicular orientation to a plane of the casting mold.

15. The method of claim 13, wherein the luminous point is cast to a depth, which corresponds to a diameter of the luminous point.

16. The method of claim 13, further comprising inserting at least one structurally reinforcing element into the casting mold before filling the casting mold.

17. The method of claim 16, wherein the at least one structurally reinforcing element is a glass-fiber mat.

18. The method of claim 13, wherein the luminous point is pressed onto the casting mold when the casting mold is filled.

19. The method of claim 17, wherein the casting mold has at least one projection into which the luminous point is inserted.

20. The method of claim 19, wherein the at least one projection is formed so that formed elements assigned to the luminous point and projecting from the plane of the signal plate are produced at the same time during filling.

21. The method of claim 20, further comprising inserting at least one further structurally reinforcing element into the projection before filling the casting mold.

22. The method of claim 21, further comprising bending a region of the glass-fiber mat, on which the luminous point is configured to rest, into the projection as the further structurally reinforcing element.

23. A method for producing a signal plate, comprising:
providing a casting mold corresponding to an external form of the signal plate;
inserting at least one receptacle into the casting mold;
filling the casting mold with a free-flowing curable plastic to create a casting;
curing the plastic;
removing the casting; and
inserting a luminous point into the at least one receptacle.

24. The method of claim 23, wherein the receptacle has a substantially cylindrical housing and is inserted into the casting mold in a substantially perpendicular orientation to a plane of the casting mold.

25. The method of claim 23, wherein the receptacle is cast to a depth, which corresponds to a diameter of the receptacle.

26. The method of claim 23, further comprising inserting at least one structurally reinforcing element into the casting mold before filling the casting mold.

27. The method of claim 23, wherein the receptacle is pressed onto the casting mold when the casting mold is filled.

28. The method of claim 23, wherein the casting mold has at least one projection into which the receptacle is inserted.

29. The method of claim 28, wherein the at least one projection is formed so that formed elements assigned to a luminous point and projecting from the plane of the signal plate are produced at the same time during filling.

30. The method of claim 29, further comprising inserting at least one further structurally reinforcing element into the projection before filling the casting mold.

31. A traffic signal, comprising:
a signal plate produced from plastic casting; and
at least one of a luminous point and an empty receptacle cast into the signal plate with a friction lock and form fit.

32. The traffic signal of claim 31, further comprising at least one structurally reinforcing element cast into the signal plate.
